(19) United States
(12) Patent Application Publication
(10) Pub. No.: US 2019/0188673 A1
(43) Pub. Date: Jun. 20, 2019

(54) COMMODITY INFORMATION READING APPARATUS

(71) Applicant: TOSHIBA TEC KABUSHIKI KAISHA, Tokyo (JP)

(72) Inventor: Shigeaki SUZUKI, Gotemba Shizuoka (JP)

(73) Assignee: TOSHIBA TEC KABUSHIKI KAISHA, Tokyo (JP)

(21) Appl. No.: 16/217,573

(22) Filed: Dec. 12, 2018

(30) Foreign Application Priority Data
Dec. 15, 2017 (JP) 2017-240895

(51) Int. Cl. G06Q 20/20; G06K 7/10

(52) U.S. Cl. CPC G06Q 20/208; G06Q 20/204; G06K 7/10415

(57) ABSTRACT

A commodity information reading apparatus includes a first support configured to support a commodity to be read. A wireless tag receiving unit is located at an upper part of the first support, includes an antenna for transmitting and receiving a signal, and is configured to receive first commodity identification information identifying the commodity that responds to the signal transmitted from the antenna, from a wireless tag attached to the commodity moved within a predetermined receivable area provided in the upper part of the first support.

### CROSS-REFERENCE TO RELATED APPLICATION

This application is based upon and claims the benefit of priority from Japanese Patent Application No. 2017-240895, filed in Dec. 15, 2017, the entire contents of which are incorporated herein by reference.

### FIELD

Embodiments described herein relate generally to a commodity information reading apparatus.

### BACKGROUND

In the related art, a wireless tag storing commodity identification information is attached to a commodity and a commodity information reading apparatus executes a sales registration processing for selling the commodity based on wireless tag information received from the wireless tag in response to a signal transmitted from the commodity information reading apparatus. Such a commodity information reading apparatus transmits a reading signal to wireless tags respectively attached to a plurality of commodities placed in one place, and receives the wireless tag information of the wireless tag that responded.

However, if there is a commodity of a container of material that does not allow radio waves to pass through such as metal among the placed commodities (hereinafter referred to as “non-passing commodity”), there is a possibility that the signal transmitted from the commodity information reading apparatus or the wireless tag information transmitted from the wireless tag that responded, is blocked by the non-passing commodity. When the signal or the information is blocked, the commodity information reading apparatus may not be able to receive the wireless tag information of all the placed commodities. Therefore, an operator needs to confirm whether the number of pieces of the wireless tag information received by the commodity information reading apparatus coincides with the number of the commodities placed on sale.

### DESCRIPTION OF THE DRAWINGS

FIG. 1 is a perspective view showing an appearance of a self-checkout POS terminal according to at least one embodiment.

FIG. 2 is a block diagram showing a hardware configuration of the self-checkout POS terminal.

FIG. 3 is a memory map showing a part of a commodity master of the self-checkout POS terminal.

FIG. 4 is a functional block diagram showing a functional configuration of the self-checkout POS terminal.

FIG. 5 is a flowchart showing control processing in the self-checkout POS terminal.

### DETAILED DESCRIPTION

An object of embodiments is to provide a commodity information reading apparatus that can reliably receive wireless tag information from a wireless tag attached to a commodity.

In general, according to at least one embodiment, there is provided a commodity information reading apparatus including a first placing unit configured to place a commodity to be read, and a wireless tag receiving unit (receiver) that is located at an upper part of the first placing unit (support), includes an antenna for transmitting and receiving a signal, and is configured to receive first commodity identification information identifying the commodity that responds to the signal transmitted from the antenna, from a wireless tag attached to the commodity moved within a predetermined receivable area provided in the upper part of the first placing unit from the first placing unit.

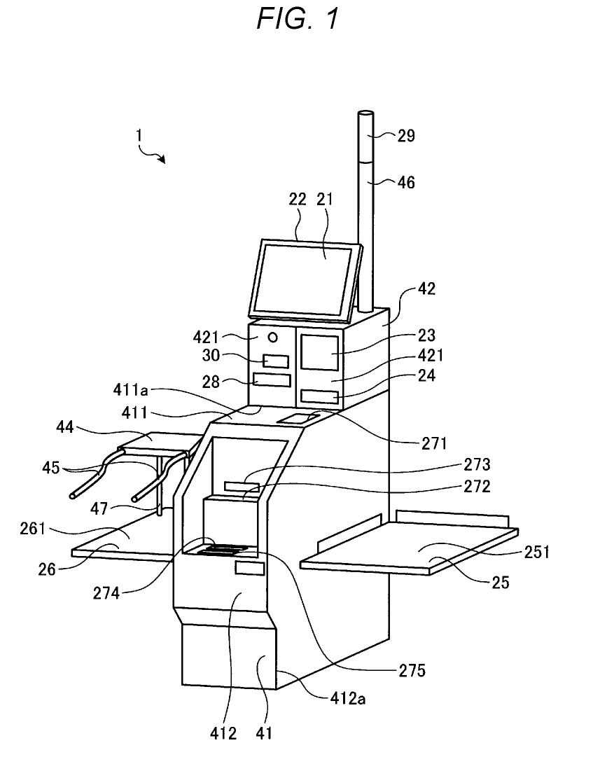

Hereinafter, with reference to the attached drawings of FIGS. 1 to 5, a commodity information reading apparatus according to at least one embodiment will be described. In the at least one embodiment, a self-checkout point of sales (POS) terminal in which a customer performs a registration operation and an accounting operation will be described as a commodity information reading apparatus. Note that, the invention is not limited by the embodiments described below.

FIG. 1 is a perspective view showing an appearance of a self-checkout POS terminal 1. The self-checkout POS terminal 1 includes a registration unit that reads a commodity code (second commodity identification information) identifying a commodity to be purchased, and an accounting unit that performs an accounting operation based on commodity information corresponding to the read commodity code. Both the registration operation at the registration unit and the accounting operation at the accounting unit are performed by the customer. The commodity code is code information for identifying a commodity. The self-checkout POS terminal 1 executes a sales registration processing based on the registration operation performed by the customer. The self-checkout POS terminal 1 also executes an accounting processing based on the accounting operation performed by the customer.

The sales registration processing is a processing of displaying and storing commodity information such as a commodity name and a price of a corresponding commodity based on an inputted commodity code. The accounting processing is a processing of displaying a total amount for transactions based on commodity information on which the sales registration processing is performed, accounting based on a deposit received from the customer, and issuing a receipt. A transaction processing includes the sales registration processing and the accounting processing. Transaction information includes the commodity information and accounting information.

As shown in FIG. 1, the self-checkout POS terminal 1 includes a first housing 41 and a second housing 42. The first housing 41 houses a coin change machine and a bill change machine (collectively referred to as “change machine 27”) and the like therein. The change machine 27 stores coins and bills deposited from the customer by denomination. The change machine 27 also pays out changes to the customer.

The first housing 41 includes a first door 411 and a second door 412 both of which can be opened and closed. The first door 411 pivots vertically about a hinge unit 411a. The second door 412 pivots horizontally about a hinge unit 412a. The first door 411 interferes with the second door 412, and in order to open the second door 412, the first door 411 needs to be opened in an upward direction. The second door 412 cannot be opened alone, when both the first door 411 and the second door 412 are closed.

As the first door 411 pivots upward, an upper inside of the first housing 41 is opened, and the change machine 27 is exposed. Also, as the second door 412 pivots rightward, a lower inside of the first housing 41 is opened, and a control device (not shown) is exposed.

The first door 411 includes a deposit slot 271, a coin output slot 273, and a receiving tray 272. The deposit slot 271 is located on an upper surface of the first door 411 and is a slot serving as an inserting port of coins for depositing in the change machine 27. The coin output slot 273 is a slot that opens a dispensing port for paying out the coins from the change machine 27. The receiving tray 272 is a tray for receiving change coins paid out from the change machine 27.

The first door 411 includes a deposit slot 274 and a withdraw slot 275. The deposit slot 274 is a slot serving as an inserting port of bills for depositing in the change machine 27. The withdraw slot 275 is a slot serving as a dispensing port for paying out change bills paid out from the change machine 27 in an upward direction.

The second housing 42 is provided on an upper portion of the first housing 41. The second housing 42 houses a code reading unit 23, a printing unit 24, a card unit 28, and a wireless tag receiving unit 30 therein. The code reading unit 23 (code reader) reads a symbol (for example, a bar code or a two-dimensional code) attached to a commodity located in a readable area that is in front of the code reading unit 23. The code reading unit 23 also optically reads a symbol attached to a commodity passing through the readable area that is a space in front of the code reading unit 23. The readable area is located at an upper part of a placing table 25 and a placing table 26, which will be described later. The code reading unit 23 acquires a commodity code identifying a commodity based on the read symbol. Hereinafter, a processing of reading a symbol and acquiring a commodity code based on the read symbol is simplified and described as “read a commodity code”. The readable area is a space in a predetermined range (for example, 30 cm) in front of the code reading unit 23 (near side in FIG. 1).

The wireless tag receiving unit 30 includes a planar antenna that transmits and receives signals. The wireless tag receiving unit 30 receives wireless tag information (first commodity identification information) including a commodity code attached to a commodity by the antenna. The wireless tag receiving unit 30 radially transmits signals from the antenna toward the wireless tag. Since the signal is a weak radio wave, the signal transmitted from the wireless tag receiving unit 30 can be received only by the wireless tag which is located in front of the antenna of the wireless tag receiving unit 30, and located in a predetermined receivable area within a predetermined range (for example, 30 cm) from the wireless tag receiving unit 30. The receivable area is located at an upper part of the placing table 25 and the placing table 26, which will be described later. The signal transmitted from the wireless tag receiving unit 30 can be received only by the wireless tag that passes through inside the receivable area within the predetermined range from the wireless tag receiving unit 30. The wireless tag receiving the signal transmits the wireless tag information to the wireless tag receiving unit 30. The wireless tag information includes an individual identification number of a commodity identifying the particular commodity (individual identification numbers are different if individuals are different, even though commodities have the same commodity code) and a commodity code identifying the commodity. That is, the wireless tag information is information for identifying a commodity. The wireless tag receiving unit 30 receives the wireless tag information transmitted from the wireless tag.

Note that, a part or all of the readable area in which a symbol can be read by the code reading unit 23 and the receivable area in which signals transmitted from the wireless tag receiving unit 30 by the wireless tag can be received, overlap each other. That is, in an overlapped area, the code reading unit 23 is capable of reading a symbol and the wireless tag receiving unit 30 is capable of receiving wireless tag information.

The printing unit 24 prints commodity information and accounting information of a commodity purchased by the customer and issues a receipt. The card unit 28 reads customer identification information from, for example, an inserted credit card. The self-checkout POS terminal 1 executes the accounting processing based on the customer identification information read by the card unit 28.

The second housing 42 includes a display unit 22 at an upper portion. The display unit 22 displays commodity information of a commodity in which a registration operation is performed by the customer. The display unit 22 also displays accounting information in which the self-checkout POS terminal 1 executed an accounting processing in accordance with an accounting operation by the customer. The display unit 22 also displays a guidance for the customer to appropriately perform the registration operation and the accounting operation. In addition, the display unit 22 displays a cancellation method for a misoperation and a calling method of an attendant.

The display unit 22 includes a touch panel 21 on a surface. The touch panel 21 serves as a key. By operating the touch panel 21 at positions corresponding to various keys displayed on the display unit 22, the keys are operated.

The second housing 42 includes a cylindrical pole 46 extending to an upper portion, at a rear. At an upper end portion of the pole 46, a light emitting unit 29 that emits a light when the customer performs an operation to call an attendant is provided.

The first housing 41 includes the placing table 25 (first placing unit or first support) and the placing table 26 (second placing unit or second support) on the left side and the right side. The placing table 25 includes a first measuring unit 251. The placing table 26 includes a second measuring unit 261.

The placing table 25 is a table on which a basket containing a commodity to purchase or a commodity is placed. When the basket containing the commodity is placed on the placing table 25, the first measuring unit 251 measures a total weight of the placed basket and the commodity in the basket. When the commodity is directly placed on the placing table 25, the first measuring unit 251 measures a total weight of the placed commodities. The placing table 26 is a table on which the commodity taken out from the placing table 25 is placed. The second measuring unit 261 measures a total weight of the commodities placed on the placing table 26.

The placing table 26 includes two supporting posts 47 extending upward from an upper surface of the placing table 26, a temporary placing table 44 formed on the supporting posts 47, and two extending rods 45. The extending rod 45 is a rod on which a bag such as a plastic bag (not shown) which contains a commodity in which a commodity code is read by the code reading unit 23, is hooked. The bag is opened with a handle hooked on the extending rod 45, and a customer can easily insert the commodity. The temporary placing table 44 is a table for temporarily placing commodities (tofu or eggs) which are easily broken in shape among the commodities in which the commodity code is read by the code reading unit 23. The commodity placed on the temporary placing table 44 is put in the bag at the end.

The commodity has a symbol attached. The commodity also has a wireless tag affixed. Note that, it is preferable that the wireless tag is affixed in a vicinity of the symbol. The wireless tag is affixed in the vicinity of the symbol means that the wireless tag affixed to the commodity is affixed to a position facing a direction of the wireless tag receiving unit 30, when an operator, who is a customer, performs a symbol reading operation with the symbol attached to the commodity facing a reading window (not shown) of the code reading unit 23, for example. In at least one embodiment, both the code reading unit 23 and the wireless tag receiving unit 30 are provided on a front face 421 side. Accordingly, the wireless tag is affixed in the vicinity of the symbol means that the wireless tag is also affixed so as to face the front face 421, when the operator directs the symbol attached to the commodity to face the front face 421 so that the code reading unit 23 can read the symbol. The wireless tag need not be affixed in the vicinity of the symbol, and the wireless tag may not be affixed in the vicinity of the symbol as long as the wireless tag receiving unit 30 can receive the wireless tag information located in the receivable area when the operator takes out the commodity placed on the placing table 25 and performs a series of operations of causing the code reading unit 23 to read the symbol or when the code reading unit 23 reads the symbol of the commodity in the readable area.

The customer takes out the commodity placed on the placing table 25 and makes the commodity pass through the readable area of the front of the code reading unit 23 and the receivable area near the wireless tag receiving unit 30 to be described later. Thereafter, the customer inserts the commodity into the bag set on the placing table 26. The first measuring unit 251 measures a weight reduced when the commodity is taken out of the basket placed on the placing table 25 (that is, the weight of the taken out commodity). The second measuring unit 261 measures a weight increased when the commodity is put on the placing table 26 (that is, the weight of the inserted commodity). Depending on whether both weight changes are equal or not, a control unit 100, which will be described later, determines whether the customer is correctly operating.

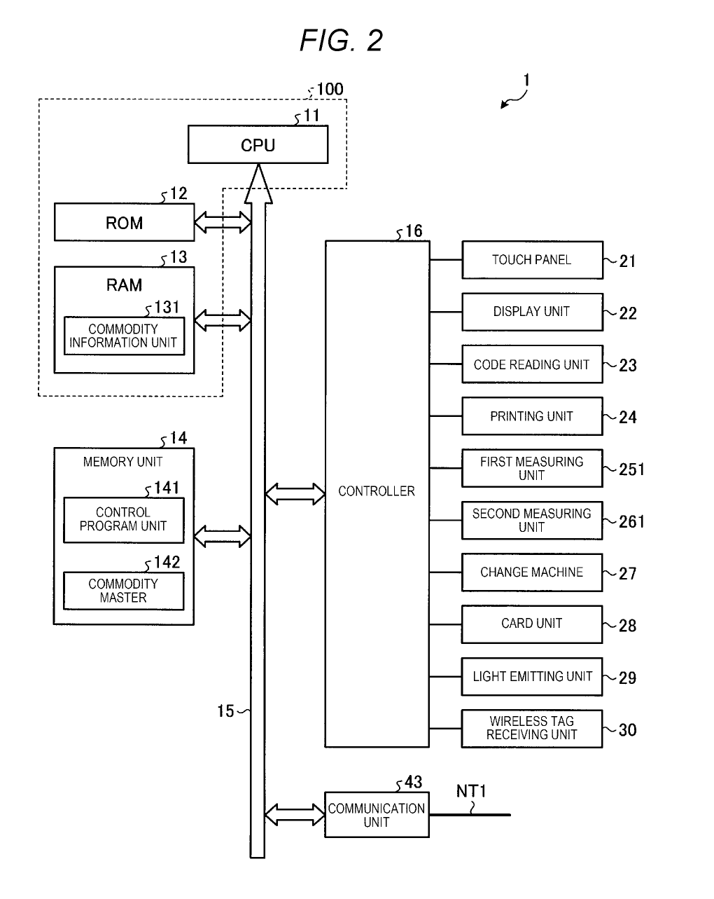

A hardware configuration of the self-checkout POS terminal 1 will be described from here. FIG. 2 is a block diagram showing the hardware configuration of the self-checkout POS terminal 1. As shown in FIG. 2, the self-checkout POS terminal 1 includes a central processing unit (CPU) 11, a read only memory (ROM) 12, a random access memory (RAM) 13, a memory unit 14, and the like. The CPU 11 is a control subject. The ROM 12 stores various programs. The RAM 13 loads various data. The memory unit 14 stores various programs. The CPU 11, the ROM 12, the RAM 13, and the memory unit 14 are connected to each other via a data bus 15. The CPU 11, the ROM 12, and the RAM 13 configure the control unit 100. That is, the control unit 100 executes a control processing to be described later by operating the CPU 11 according to a control program stored in the ROM 12 or the memory unit 14 and loaded in the RAM 13.

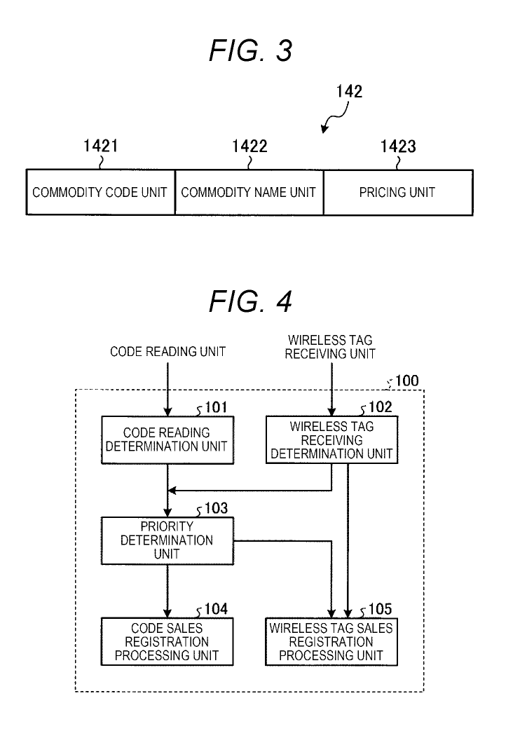

The RAM 13 has a commodity information unit 131. The commodity information unit 131 stores commodity information of a commodity performed the sales registration processing. The memory unit 14 is configured to a nonvolatile memory such as a hard disk drive (HDD) or a flash memory that retains stored information even when a power is turned off, and includes a control program unit 141 that stores a control program. The memory unit 14 includes a commodity master 142. The commodity master 142 will be described later with reference to FIG. 3.

The control unit 100 is connected to the touch panel 21, the display unit 22, the code reading unit 23, the printing unit 24, the first measuring unit 251, the second measuring unit 261, the change machine 27, the card unit 28, the light emitting unit 29, and the wireless tag receiving unit 30 via the data bus 15 and a controller 16.

The control unit 100 is connected to a communication unit 43 via the data bus 15. The communication unit 43 transmits and receives information with another self-checkout POS terminal 1 or an attendant PC or an upper server (neither is shown) via a communication line NT1.

FIG. 3 is a memory map showing a part of the commodity master 142 (storage unit). The commodity master 142 stores various kinds of information relating to the commodity. As shown in FIG. 3, the commodity master 142 includes a commodity code unit 1421, a commodity name unit 1422, and a pricing unit 1423

The commodity code unit 1421 stores a commodity code for identifying a commodity. The commodity name unit 1422 stores a commodity name of the commodity identified by the commodity code in association with the commodity code. The pricing unit 1423 stores a price of the commodity identified by the commodity code in association with the commodity code.

A functional configuration of the self-checkout POS terminal 1 will be described from here. FIG. 4 is a functional block diagram showing the functional configuration of the self-checkout POS terminal 1. As shown in FIG. 4, by following the control program stored in the ROM 12 or the control program unit 141 of the memory unit 14, the control unit 100 (controller) functions as a code reading determination unit 101, a wireless tag receiving determination unit 102, a priority determination unit 103, a code sales registration processing unit 104, and a wireless tag sales registration processing unit 105.

The code reading determination unit 101 determines whether or not the code reading unit 23 read the commodity code.

The wireless tag receiving determination unit 102 determines whether or not the wireless tag receiving unit 30 received the wireless tag information.

The priority determination unit 103 determines whether or not the wireless tag receiving unit 30 received the wireless tag information for the same commodity and the code reading unit 23 read the commodity code. Generally, when the commodity passes through, since the wireless tag receiving unit 30 receives wireless tag information faster than the code reading unit 23 reads a commodity code, if the wireless tag receiving unit 30 received the wireless tag information at the time when the code reading unit 23 reads the commodity code, it is determined that the wireless tag receiving unit 30 received the wireless tag information on the same commodity and the code reading unit 23 read the commodity code.

When the priority determination unit 103 determines that the code reading determination unit 101 determined the commodity code was read and the wireless tag receiving determination unit 102 determined that the wireless tag information was not received, the code sales registration processing unit 104 executes the sales registration processing based on the commodity code read by the code reading unit 23. That is, based on the commodity code read by the code reading unit 23, the code sales registration processing unit 104 reads the commodity name and the price associated with the commodity code from the commodity master 142 and stores the commodity name and the price in the commodity information unit 131.

When it is determined that the wireless tag receiving unit 30 received the wireless tag information, the wireless tag sales registration processing unit 105 executes the sales registration processing based on the commodity code included in the wireless tag information received by the wireless tag receiving unit 30. That is, based on the commodity code included in the wireless tag information received by the wireless tag receiving unit 30, the wireless tag sales registration processing unit 105 reads the commodity name and the price associated with the commodity code from the commodity master 142, and stores the commodity name and the price in the commodity information unit 131. When the priority determination unit 103 determines that the code reading determination unit 101 determined the commodity code was read and the wireless tag receiving determination unit 102 determined that the wireless tag information was received, the wireless tag sales registration processing unit 105 executes the sales registration processing based on the commodity code included in the wireless tag information received by the wireless tag receiving unit 30.

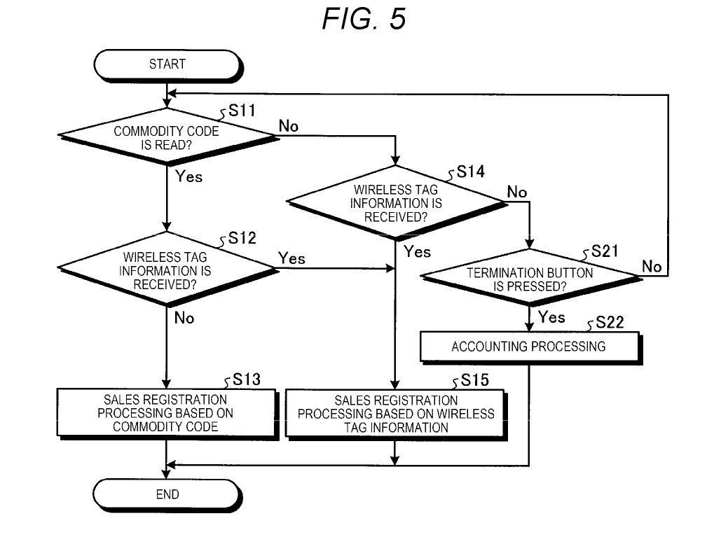

A control processing of the self-checkout POS terminal 1 will be described from here. FIG. 5 is a flowchart showing the control processing in the self-checkout POS terminal 1.

The code reading determination unit 101 determines whether or not the code reading unit 23 read the commodity code (Act 11). When the code reading determination unit 101 determines that the code reading unit 23 did not read the commodity code (No in Act 11), the wireless tag receiving determination unit 102 determines whether or not the wireless tag receiving unit 30 received wireless tag information (Act 14).

When the priority determination unit 103 determines that the code reading determination unit 101 determined the commodity code was read (Yes in Act 11), the wireless tag receiving determination unit 102 determines whether or not the wireless tag information was received for the same commodity (Act 12). When the priority determination unit 103 determines that the wireless tag receiving determination unit 102 determined the wireless tag information was not received for the same commodity (No in Act 12), the code sales registration processing unit 104 executes the sales registration processing based on the commodity code read by the code reading unit 23 (Act 13). Then, the control unit 100 terminates the processing.

On the other hand, when the priority determination unit 103 determines that the wireless tag receiving determination unit 102 determined the wireless tag information was received for the same commodity (Yes in Act 12), the wireless tag sales registration processing unit 105 executes the sales registration processing based on the commodity code included in the wireless tag information received by the wireless tag receiving unit 30 (Act 15). Then, the control unit 100 terminates the processing.

When the wireless tag receiving determination unit 102 determines that the wireless tag receiving unit 30 received the wireless tag information (Yes in Act 14), the wireless tag sales registration processing unit 105 executes the sales registration processing based on the commodity code included in the wireless tag information received by the wireless tag receiving unit 30 (Act 15). That is, the control unit 100 executes the sales registration processing on a commodity that does not read a commodity code for some reason, based on the commodity code included in the wireless tag information received by the wireless tag receiving unit 30 (Act 15). Then, the control unit 100 terminates the processing.

When the wireless tag receiving determination unit 102 determines that the wireless tag receiving unit 30 did not receive the wireless tag information (No in Act 14), the control unit 100 determines whether a termination button (not shown) provided on the touch panel 21 is operated (Act 21). When the control unit 100 determines that the termination button is operated (Yes in Act 21), the control unit 100 executes the accounting processing based on the commodity information stored in the commodity information unit 131 (Act 22). Then, the control unit 100 terminates the processing. When the control unit 100 determines that the termination button is not operated (No in Act 21), the control unit 100 returns to Act 11.

According to the self-checkout POS terminal 1 of at least one embodiment, when the operator lifts up a commodity placed on the placing table 25, searches for a symbol, and performs an operation to pass through the front of the code reading unit 23 toward the code reading unit 23, the wireless tag receiving unit 30 receives the wireless tag information from the wireless tag affixed to the commodity that passed through the receivable area. Therefore, if the operator performs an operation to cause the code reading unit 23 to read the symbol attached to the commodity toward the code reading unit 23, the wireless tag information corresponding to the commodity can be received from the wireless tag affixed to the commodity.

According to the self-checkout POS terminal 1 of at least one embodiment, since the readable area and the receivable area are partially overlapped or entirely overlapped, if the operator performs an operation to read the symbol attached to the commodity in an overlapped area, the wireless tag information corresponding to the commodity can be received from the wireless tag attached to the commodity at the same time.

According to the self-checkout POS terminal 1 of the embodiment, when the code reading unit 23 read the commodity code and the wireless tag receiving unit 30 received the wireless tag information for the same commodity, the sales registration processing is executed based on the wireless tag information received by the wireless tag receiving unit 30. Therefore, management of each particular commodity can be performed based on the individual identification number included in the wireless tag information.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein maybe made without departing from the spirit of the inventions. The accompanying claims and their equivalents are intended to cover such forms or modifications as would fall within the scope and spirit of the inventions.

For example, in at least one embodiment, the self-checkout POS terminal 1 is described as an example of a commodity information reading apparatus. However, without being limited to this, for example, a commodity information registration apparatus of a semi self-checkout POS including a commodity information registration apparatus operated by a store clerk and an accounting apparatus operated by a customer may be used as the commodity information reading apparatus. A commodity sales data processing apparatus for the store clerk to perform a sales registration operation and an accounting operation may be used as the commodity information reading apparatus.

In at least one embodiment, the code reading unit 23 optically reads the symbol to acquire the commodity code. However, without being limited to this, the code reading unit 23 may capture a symbol and acquire a commodity code based on the captured symbol.

In at least one embodiment, the commodity code is described as an example of the second commodity identification information. However, without being limited to this, the second commodity identification information may be information other than a code as long as the information identifies a commodity.

At least one embodiment includes the code reading unit 23 for reading the commodity code and the wireless tag receiving unit 30 for receiving the wireless tag information. However, without being limited to this, the code reading unit 23 is not an essential configuration. In short, the wireless tag receiving unit 30 may receive wireless tag information when the operator performs an operation to hold a symbol over the wireless tag receiving unit 30.

Note that, a program executed by the self-checkout POS terminal 1 of the embodiment is provided by being recorded in a computer-readable recording medium such as a CD-ROM, a flexible disk (FD), a CD-R, a digital versatile disc (DVD) or the like in a file in installable format or executable format.

The program executed by the self-checkout POS terminal 1 of at least one embodiment may be stored on a computer connected to a network such as the Internet and provided by being downloaded via the network. The program executed by the self-checkout POS terminal 1 of at least one embodiment may be provided or distributed via the network such as the Internet.

In addition, the program executed by the self-checkout POS terminal 1 of at least one embodiment may be provided by being incorporated in a ROM or the like in advance.

What is claimed is:

1. A commodity information reading apparatus comprising:
a first support configured to support a commodity to be read; and
a wireless tag receiver located at an upper part of the first support, and including an antenna configured to transmit and receive a signal,
the wireless tag receiver configured to receive first commodity identification information identifying the commodity that responds to the signal transmitted from the antenna, from a wireless tag attached to the commodity moved within a predetermined receivable area provided in the upper part of the first support.

2. The apparatus according to claim 1, further comprising:
a code reader provided in a vicinity of the wireless tag receiver and configured to read second commodity identification information identifying the commodity, and attached to the commodity moved within a predetermined readable area provided in the upper part of the first support,
wherein the receivable area and the readable area overlap each other at least partially.

3. The apparatus according to claim 2, further comprising:
a second support configured to support the commodity that passed through the receivable area and provided on a side opposite to the first support, the first support and the second support sandwiching the wireless tag receiver.

4. The apparatus according to claim 2, further comprising:
a controller configured to:
execute a sales registration processing of the commodity based on the first commodity identification information when the wireless tag receiver receives the first commodity identification information and the code reader reads the second commodity identification information for a same commodity.

5. The apparatus according to claim 2,
wherein the wireless tag receiver is configured to receive the first commodity identification information from the wireless tag attached to the commodity for which an operation for reading the second commodity identification information from the code reader is performed.

6. The apparatus according to claim 2, further comprising a controller, wherein when the controller determines that the second commodity identification information was read by the code reader and the first commodity identification information was not received by the wireless tag receiver, the controller is configured to perform sales registration processing based on the second commodity identification information read by the code reader.

7. The apparatus according to claim 2, further comprising a controller, wherein when the controller determines that the first commodity identification information was received by the wireless tag receiver, the controller is configured to perform sales registration processing based on the first commodity identification information received by the wireless tag receiver.

8. A method of operating a commodity information reading apparatus including a first support configured to support a commodity to be read, and a wireless tag receiver located at an upper part of the first support, and including an antenna configured to transmit and receive a signal, the method comprising:
receiving, via the wireless tag receiver, first commodity identification information identifying the commodity that responds to the signal transmitted from the antenna, from a wireless tag attached to the commodity moved within a predetermined receivable area provided in the upper part of the first support.

9. The method according to Claim. 8, further comprising:
reading, via a code reader provided in a vicinity of the wireless tag receiver, second commodity identification information identifying the commodity, and attached to the commodity moved within a predetermined readable area provided in the upper part of the first support,
wherein the receivable area and the readable area overlap each other at least partially.

10. The method according to claim 9, wherein the commodity information reading apparatus further comprises a second support configured to support the commodity that passed through the receivable area and provided on a side opposite to the first support, the first support and the second support sandwiching the wireless tag receiver.

11. The method according to claim 9, further comprising:
executing a sales registration processing of the commodity based on the first commodity identification information when the wireless tag receiver receives the first commodity identification information and the code reader reads the second commodity identification information for a same commodity.

12. The method according to claim 9,
receiving, via the wireless tag receiver, the first commodity identification information from the wireless tag attached to the commodity for which an operation for reading the second commodity identification information from the code reader is performed.

13. The method according to claim 9, further comprising, when it is determined that the second commodity identification information was read by the code reader and the first commodity identification information was not received by the wireless tag receiver, performing sales registration processing based on the second commodity identification information read by the code reader.

14. The method according to claim 9, further comprising, when it is determined that the first commodity identification information was received by the wireless tag receiver, performing sales registration processing based on the first commodity identification information received by the wireless tag receiver.
